(19) United States
(12) Patent Application Publication
(10) Pub. No.: US 2004/0096290 A1
(43) Pub. Date: May 20, 2004

(54) Securing and holding assembly element

(76) Inventor: Ulrich Birnbaum, Penzing (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/638,160

(22) Filed: Aug. 7, 2003

(30) Foreign Application Priority Data
Aug. 8, 2002 (DE) 102 36 551.2

(51) Int. Cl. F16B 37/02

(52) U.S. Cl. 411/172

(57) ABSTRACT

An assembly element for the temporary holding and securing a first component on at least one second component includes an insertion section (2; 22; 32) having at least one receptacle (6; 25, 26; 33, 34) for receiving a fastening element (10) for attaching the first component to the second component (11), and a holding section (3; 23; 35) adjoining the insertion section (2; 22; 32) and extending substantially transverse to a plane defined by the insertion section (2; 22; 32).

### BACKGROUND OF THE INVENTION

1. Field of the Invention

The present invention relates to an assembly element for temporary holding and securing of a first component to at least one second component, in particular, for holding and securing components of an assembly system.

2. Description of the Prior Art

In steel constructions, separate components are connected with each other by welding or with rivets. These connections are expensive to produce, and modernization of the construction is possible only with high costs. In other constructions, separate components are releasably connected by using a threaded connection.

In order to improve the flexibility of steel constructions, so-called assembly systems are used. In an assembly system, there is provided, e.g., a support with a plurality of openings spaced from each other by a predetermined distance, with other components of a steel construction being secured to the support with threaded elements. When the support is formed as a closed hollow profile or the support is accessible only from one side, then, e.g., insert nuts are inserted into the openings and are pressed therein with a special tool. The insert nuts are provided with an inner thread into which threaded means can be screwed in to secure a component to a support.

The drawback of the above-described solution consists in that the openings in the support should be adapted to the diameters of the insert nuts to prevent rotation of the insert nuts in their respective openings. Further, the inner thread of the insert nut is smaller than the initial size of the opening, which does not permit to insure a sufficient strong connection, e.g., with the opening in a support having a diameter of 12 mm, only a nut with an inner thread for an M8 screw can be used. At high loads acting on a steel construction, in order to withstand these loads, large connection cross-sections of the fastening means are required in order to reduce the number of the necessary fastening elements to a minimum.

Accordingly, an object of the present invention is to provide an assembly element for releasably connecting a components to another components and which can be issued with a profile accessible only from one side.

Another object of the present invention is to provide an assembly component of the type described immediately above and which would insure a reliable engagement of the assembly element with the profile at the profile non-accessible side and with which rotation of the assembly element relative to the profile would be prevented.

A further object to present invention is to provide an assembly element which would provide for a maximum connection cross-section of an opening and would not require for its use any special tool.

### SUMMARY OF THE INVENTION

These and other objects of the present invention, which will become apparent hereinafter, are achieved by providing an assembly element for temporary holding and securing a first component on at least one second component and including an insertion section having at least one receptacle for receiving a fastening element for attaching the first component to the second component. The assembly element further includes a holding section adjoining the insertion section and extending substantially transverse to a plane defined by the insertion section.

Because the second component is formed as a profile at least one outer wall of which is provided with openings spaced from each other by a predetermined distance, the receptacle for receiving the fastening element can so be located on the insertion section that it would be received in one of the openings of the second component upon insertion of the assembly element through another opening of the second component. The fastening element is inserted through the receptacle and the opening in the second component, connecting the two components. The holding section prevents the inserted assembly element from falling into the component accessible only from one side. The holding section can also be used for temporary holding the first component until the first component is secured to the second component. In particular, with assembly systems for heavy loads, e.g., with industrial constructions, the separate components have a large weight. Therefore, the capability of the invention assembly element to temporary hold a component significantly facilitate the assembly process.

Advantageously the receptacle is provided at an end of the insertion section remote from the holding section. Thereby, a lever arm is provided on the assembly element which facilitate alignment of the receptacle with the position of the receiving opening in the second component when the assembly element is moved by the holding section. The receptacle is advantageously spaced from the end of the insertion section facing in the insertion direction, which provides a support surface on the assembly element. When a tension force is applied to the receptacle, the support surface prevents distortion of the receptacle under the action of large torque forces acting on the assembly element. The thickness of the assembly element can be rather small, which provides for economical manufacturing of the inventive assembly element.

Advantageously, for effecting alignment of the assembly element, which is inserted into the second component, the assembly element is provided with an operational section. The operational section is provided at the free end of the holding section. With the operational section, the receptacle can be pressed against the non-accessible side of the outer wall of the second component or profile before the insertion of the fastening element. The operational section can extend parallel to the plane of the insertion section, whereby the assembly element would have a Z-shaped profile. The operational section provides, upon the insertion of the assembly element in the second component, in addition, a hook-shaped receiving element for temporary holding the first component until it is secured to the second component.

Advantageously, the operational section has a greater width than the insertion section, with the width of the operational section being greater than the inner dimension of the opening in the profile the assembly element is inserted through. With such an operational section, on one hand, falling of the assembly element, which is inserted in the profile, inside the profile is prevented and, on the other hand, handling of the assembly element during insertion and fastening processes is facilitated.

Advantageously, the operational section extends to the plane of the insertion section at an angle of, preferably, from 5° to 30°. Thereby, an application pressure can be applied to the non-accessible side of the outer wall of the second component, which prevents a pivotal movement of the assembly element when the fastening elements are inserted into the receptacles. Moreover, the suspension of the first component on the assembly element for its temporary holding thereon is simplified.

Advantageously, the holding section has a height which corresponds at least to the thickness of the outer wall of the second component, e.g., of the second component-forming profile. With such formation of the assembly element, wedging of the assembly element during its insertion in the profile and during its alignment is reliably prevented.

Advantageously, the receptacle has an inner thread, and the fastening element has a threaded profile cooperating with the inner thread. This insures a releasable connection of the first component with the second component. Furthermore all the components of the entire steel construction can be connected in a first step, with the steel construction being subsequently straightened. After the steel construction is straightened, all of the connections are fixedly screwed together, e.g., tightened. According to one embodiment of the invention, the receptacle can be formed as a bore, and as a fastening element, instead of a threaded element, e.g., a blind rivet can be used.

Advantageously, the receptacle can be formed with a collar. Preferably, the collar is provided on a side of the assembly element, on the insertion section, adjacent to the second component. The collar forms centering means on the assembly element as the outer dimensions of the collar, preferably, are smaller than the inner dimension of the openings in the second component. The collar outer surface has a funnel-shaped profile, which facilitates centering. When the receptacle has an inner thread, the connection thread is formed in the collar. Thereby, even at a small thickness of the assembly element, an adequate number of thread turns can be provided which permits to obtain a stable connection with the fastening element. When the centering of the assembly element is not very important, the collar can be formed on a side of the assembly element, on the insertion section, remote from the second component. In this case, the collar serves only for a local increase of the thickness of material of the insertion section in order to insure that an adequate number of thread turns is obtained for forming a stable connection with the fastening element.

Advantageously, two receptacles for receiving fastening elements are provided on the insertion section. At least two receptacles are necessary because at high loads which, e.g., occur in industrial constructions, the connection cross-section of only one fastening element is not sufficient for transmitting the load. The insertion section has a length which is at least equal to a distance between the opening in the second component, through which it is inserted, to the next adjacent opening in the second component, so that the first component can be secured to the second component with two fastening elements.

When the insertion section has at least two receptacle for receiving fastening elements, the holding section can be formed by one of the fastening elements. This construction of the assembly element is particular advantageous when for constructional or aesthetic reasons, the assembly element should not be seen from outside. When a fastening element serves as a holding element the assembly element is secured in the second component against sliding therealong. The fastening element, which serves as a holding section, can be used for aligning the assembly element with at least one other fastening element.

According to a further embodiment of the present invention, the operational section can be formed as a removable part of the assembly element. To this end, the operational section is releasably connected with the insertion section or the holding section by engaging a respective section or by a clip. As soon as a fastening element is received in the receptacle, the operational section can be removed. The removed operational section can be formed, e.g., of a plastic material. Moreover, the removable operational section can be used for mounting of another assembly element. The removable operational section can advantageously be used during disassembly of a steel construction when it is secured to the assembly element, so that the assembly element would not fall into the non-accessible second component when the fastening element(s) is/are removed.

The assembly element is formed, preferably of metal as a stamped flexible part. The assembly element can also be formed of a suitable plastic material.

The novel features of the picture invention, which are considered as characteristic for the invention itself, however both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a perspective view of a first embodiment of a securing and holding assembly element;

FIG. 2 a cross-sectional view of the securing and holding assembly element shown in FIG. 1 and arranged in a support;

FIG. 3 a plan view of a second embodiment of a securing and holding assembly element according to the present invention; and

FIG. 4 a perspective view of a third embodiment of a securing and holding assembly element according to the present invention.

### DETAILED DESCRIPTION OF THE PREFERRED EMBODIMENTS

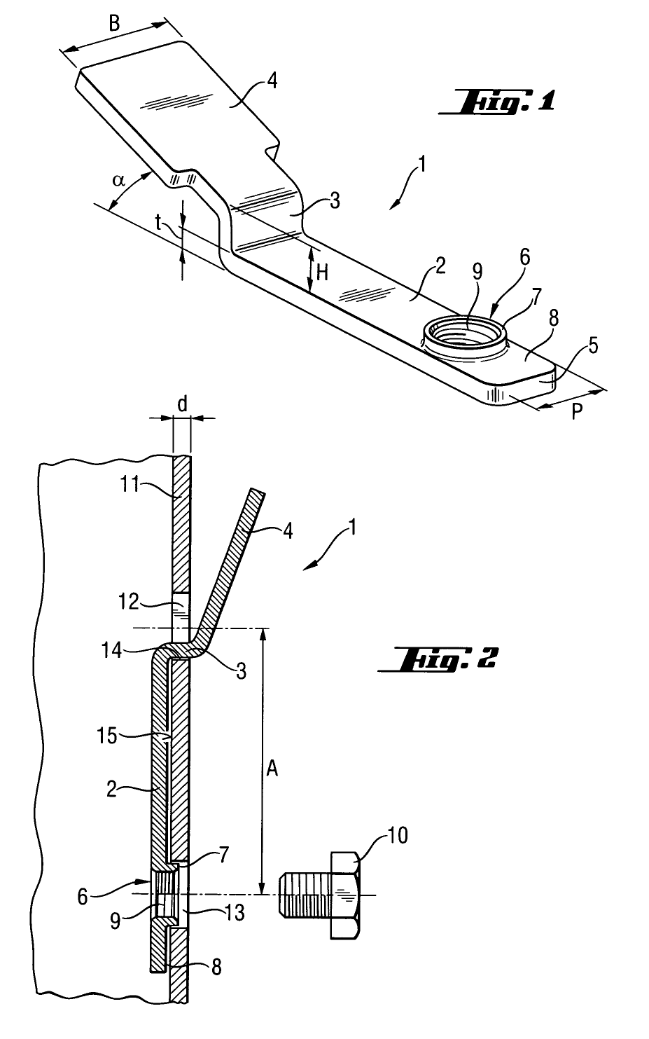

A securing and holding assembly element 1 according to the present invention, a first embodiment of which is shown in FIGS. 1-2, has an insertion section 2, a holding section 3, and an operational section 4. In the region of the insertion direction end 5 of the insertion section 2, a receptacle 6 with an inner thread 7 is provided. The receptacle 6 is provided with a collar 7. On one hand, the collar 7 serves as centering means. On the other hand, the collar 7 insures that at small thickness of the assembly element 1, the number of turns of the inner thread in the receptacle 6 is sufficient for establishing of a reliable threaded connection. The receptacle 6 is spaced from the end 5 in order to provide a support section 8. The holding section 3 extends transverse to the insertion section 2. The height H of the holding section 3 corresponds at least to the thickness d of an outer wall of a profile 11 in which the assembly element 1 is inserted. The holding section 3 is adjoined by the operational section 4. In its longitudinal direction, the assembly element 1 has a Z-shaped profile, with the operational section 4 extending to a plane of the insertion section 2 at an angle α of 20°. The operational section 4 has a width B that is greater than the width P of the insertion section 2. This prevents the assembly element 1 from falling in after it has been inserted in the profile 11.

The profile 11, which is shown in FIG. 2 and which serves as a support, is formed in the embodiment shown in FIGS. 1-2 as a closed hollow profile. FIG. 2 shows a section of an outer wall of the profile 11 in which a plurality of openings is provided (only two openings 12 and 13 are shown in the drawing). The openings are spaced from each other by a predetermined distance.

The openings 12 and 13, which are shown in FIG. 2, are formed as square openings with an inner dimension of 13.5 mm. The square cross-section of the openings 12 and 13 insures a simple positioning of the assembly element 1 on the profile 11 relative to the openings 12 and 13, with the profile 11 providing a predetermined bearing surface for the assembly element 1. In the embodiment shown in FIG. 2, the distance between the centers of the openings 12 and 13 amounts to 50 mm. The dimensions of the assembly element 1 are adapted to the dimensions of the profile 11. In the embodiment of the assembly element 1 shown in FIG. 1, the width P of the insertion section 2 amounts to 13 mm, and the width B of the operational section 4 amounts to 20 mm. The distance between the edge of the holding section 3 and the axis of the receptacle 6 is adapted to the distance A between the centers or axes of the openings 12 and 13 and amounts in the embodiment shown in FIGS. 1-2 to 45 mm.

The assembly element 1 is inserted into profile 1 with its insertion section 2, with the holding section 3 engaging the lower edge 14 of the opening 12. The operational section 4 can support a component that should be secured to the profile 11 and that, thus, can be temporary supported until it is permanenly secured to the profile 11. This enables a simple assembly of an entire construction even when large and, thus, heavy components are used.

The assembly element 1 is aligned with the profile 11 with the operational section 4. When the receptacle 6 is received in the opening 13, a screw 10 is screwed into the receptacle. In order to prevent the assembly element 1 from pivoting upon the screw 10 being screwed in, the operational section 4 is pressed toward the profile 11 which results in the insertion section 2 being pressed against the inner surface 15 of the profile 11, whereby pivoting of the assembly element 1 is prevented. The bearing or support section 8 prevents a torque, which is generated upon a tension load being applied to the receptacle 6, from acting on the insertion section 2 and/or prevents the inner thread of the receptacle 6 from being distorted as a result of a load being applied to the receptacle 6.

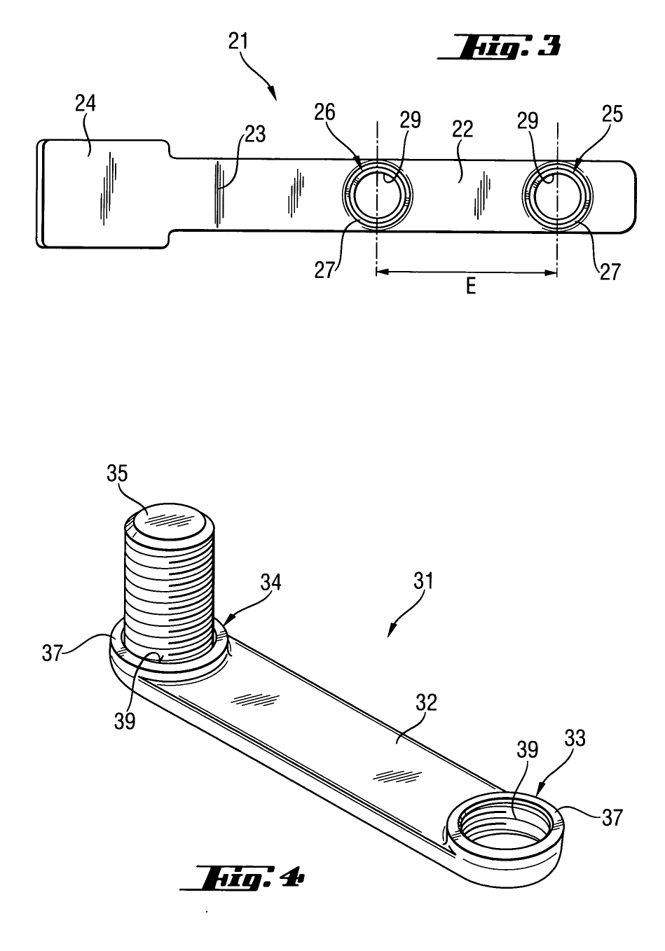

In the embodiment shown in FIG. 3, the assembly element 21 has an insertion section 22, a holding section 23, and an operational section 24 and is formed, in the longitudinal direction, in the same way as the assembly element 1 shown in FIGS. 1-2. In distinction from the assembly element 1, two receptacles 25, 26 each having a collar 27 and an inner thread 29, are provided in the insertion section 22. The distance E between axes of the receptacles 25, 26 corresponds to the distance between the centers or axes of the openings which are formed in the profile or support the assembly element 21 is inserted in.

Because of a larger cross-section of the fastening means, the assembly element 21 can withstand higher loads than an assembly element 1 having a single receptacle 6 and thereby a smaller cross-section of the fastening means.

In the embodiment shown in FIG. 4, the assembly element 31 is formed of two parts and includes an insertion section 32 at opposite ends of which, respectively, two receptacles 33 and 34 are provided. Each of the receptacles 33, 34 has an inner thread 39 and a collar 37 which reinforces a respective end of the insertion section 32. A threaded pin 35 is inserted in the receptacle 34. The pin 35 serves as a holding section during mounting of the assembly element 31.

The assembly element 31 is inserted in a component (not shown) accessible only from one side. The threaded pin 35 is used for aligning of the assembly element 31 until the receptacle 33 is received in an appropriate opening. Instead of a threaded pin 35, a screw with a head can be used, with a washer being provided beneath the head. The assembly element 31 can be aligned with the support with the screw. The assembly element 31 is secured to the component only with one fastening element. The to-be-connected component can be temporary held at the end of the threaded pin portion accessible from outside.

Instead of a threaded pin 35, a screw can be screwed in the receptacle 34 of the assembly element 31. Advantageously, in this case, an operational section (not shown) can be releasably secured to the insertion section 31 and which can be removed after the insertion of the assembly element 31. This embodiment of an assembly element according to the present invention is particularly advantageous when the assembly element should not project above the outer wall of a support for constructional reasons or should not be seen for aesthetic reasons.

Generally, there is provided an assembly element for releasably attaching a component to another component which is insertable in a profile accessible only from one side and which reliably engages the profile from the inaccessible side and is prevented from pivoting or rotation. The assembly element according to the present invention provides for an easy assembly of steel constructions without use of special tools. In addition to its use for connection of steel construction components, the assembly element according to the present invention can be used with constructions formed of materials other than steel and which include component accessible only from one side and connectable with other components.

Though the present invention was shown and described with references to the preferred embodiments, such are merely illustrative of the present invention and are not to be constructed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. An assembly element for temporary holding and securing a first component on at least one second component, comprising an insertion section (2; 22; 32) having at least one receptacle (6; 25, 26; 33, 34) for receiving fastening means (10) for attaching the first component to the second component (11); and a holding section (3; 23; 35) adjoining the insertion section (2; 22; 32) and extending substantially transverse to a plane defined by the insertion section (2; 22; 32).

2. An assembly element according to claim 1, wherein the at least one receptacle (6; 25, 26; 33) is provided in an end region of the insertion section (2; 22; 32) remote from the holding section (3; 23; 35).

3. An assembly element according to claim 1, further comprising an operational section (4; 24) for aligning the assembly element (1; 21) with respect to the second component (11) in which the assembly element (1; 21) is inserted, the operational section (4; 24) being arranged at a free end of the holding section (3; 23).

4. An assembly element according to claim 3, wherein the operational section (4; 24) has a width (B) greater than a width of the insertion section (2; 22).

5. An assembly element according to claim 3, wherein the operational section (4; 24) extends to the plane of the insertion section (2; 22) at an angle (a) from 5° to 30°.

6. An assembly element according to claim 1, wherein the holding section (3; 23; 35) has a height (H) corresponding at least to a thickness (d) of an outer wall of the second component (11).

7. An assembly element according to claim 1, wherein the at least one receptacle (6; 25, 26; 33, 34) has an inner thread (9; 29; 39), and wherein the fastening means (10) has screw means engaging in the inner thread (9; 29; 39).

8. An assembly element according to claim 1, wherein the at least one receptacle (6; 25, 26; 33; 34) has a collar (7; 27; 37).

9. An assembly element according to claim 1, wherein the insertion section (22; 32) has at least two receptacles (25, 26; 33, 34) for receiving at least two fastening elements (10; 15).

10. An assembly element according to claim 9, wherein the holding section (35) is formed by one of the fastening elements.
